(19) United States
(12) Patent Application Publication
(10) Pub. No.: US 2013/0257574 A1
(43) Pub. Date: Oct. 3, 2013

(54) IMMERSION COOLED TOROID INDUCTOR ASSEMBLY

(71) Applicants: Robert S. DOWNING, Rockford, IL (US); Charles SHEPARD, Dekalb, IL (US)

(72) Inventors: Robert S. DOWNING, Rockford, IL (US); Charles SHEPARD, Dekalb, IL (US)

(73) Assignee: Hamilton Sundstrand Corporation, Windsor Locks, CT (US)

(21) Appl. No.: 13/438,271

(22) Filed: Apr. 3, 2012

(51) Int. Cl. H01F 27/18

(52) U.S. Cl. 336/57; 336/58

(57) ABSTRACT

An inductor assembly includes a substrate, an outer cylindrical housing arranged on the substrate, a wound inductor core arranged in the outer cylindrical housing, and a working fluid disposed in the outer cylindrical housing and in contact with the wound inductor core.

### BACKGROUND OF THE INVENTION

Generally, the present invention is directed to inductor assemblies, and more particularly, exemplary embodiments of the present invention are directed to immersion-cooled toroid inductor assemblies.

Conventionally, toroid inductor assemblies include conductive wires wrapped about an inductive core. The conductive wires are held in place with a potting compound. Cooling of conventional high power density inductors relies on conduction of the heat axially to the coldplate through the wires, the potting and the core. The inductive cores may have an operating temperature limit much lower than that of most conventional conductive wires, and therefore, limit the ability for conventional potted inductor assemblies to be used in some environments.

### BRIEF DESCRIPTION OF THE INVENTION

According to an embodiment of the present invention, An inductor assembly includes a substrate, an outer cylindrical housing arranged on the substrate, a wound inductor core arranged in the outer cylindrical housing, and a working fluid disposed in the outer cylindrical housing and in contact with the wound inductor core.

According to another embodiment of the present invention, an inductor assembly includes a substrate and an outer cylindrical housing arranged on the substrate defining an interior cavity disposed to house a working fluid and a plurality of electrical components. The inductor assembly further includes a wound inductor core arranged in the interior cavity and an inner cylindrical housing arranged through the wound inductor core. The inner cylindrical housing is configured to transmit working fluid axially through the inductor assembly.

According to yet another embodiment of the present invention, an inductor assembly includes a sealed outer cylindrical housing, a wound inductor core arranged in the sealed outer cylindrical housing, and a working fluid disposed in the sealed outer cylindrical housing and in contact with the wound inductor core.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which like numerals represent like elements:

FIG. 1 is an immersion cooled inductor assembly, according to an exemplary embodiment of the present invention;

FIG. 2 is an exploded view of the inductor assembly of FIG. 1;

FIG. 3 is a cut-away view of a portion of the inductor assembly of FIG. 1;

FIG. 4 is an isometric view of a core of the inductor assembly of FIG. 1;

FIG. 5 is a top view of a bobbin of the inductor assembly of FIG. 1;

FIG. 6 is an expanded view of the bobbin of FIG. 5; and

FIG. 7 is a detailed expanded view of a cooling channel portion of the bobbin of FIG. 5.

### DETAILED DESCRIPTION OF THE INVENTION

According to exemplary embodiments of the present invention, immersion cooled inductor assemblies are provided which overcome the drawbacks associated with potted inductor assemblies. The technical effects and benefits of exemplary embodiments include increased cooling efficiency and prolonged life of inductor assemblies.

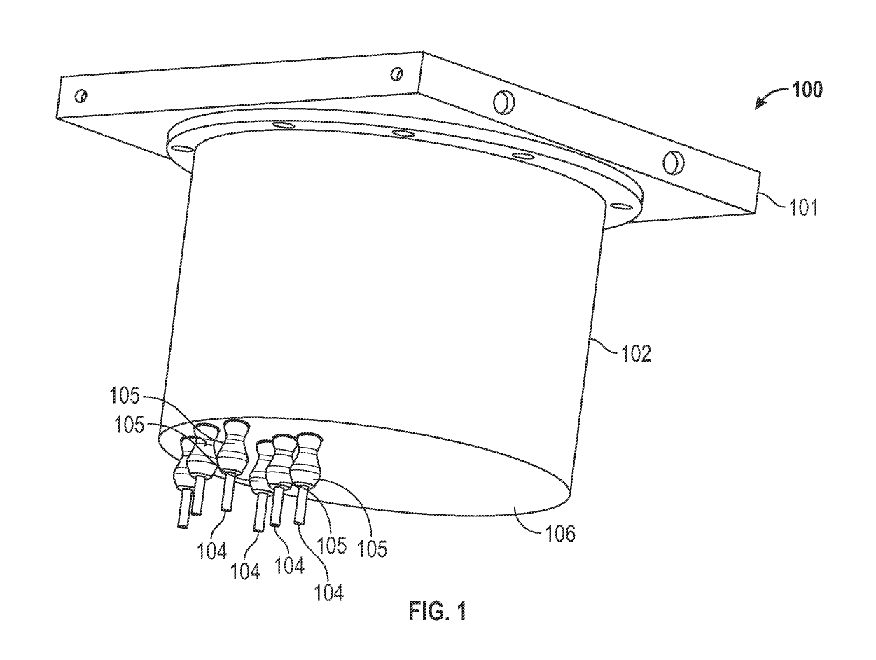

Turning now to the figures, FIG. 1 illustrates an immersion cooled inductor assembly, according to an exemplary embodiment of the present invention. The inductor assembly 100 includes a substrate 101. The substrate 101 may be a cold plate, heat dissipating substrate, or any other similar substrate with relatively low thermal resistance and/or configured to spread and dissipate heat. The inductor assembly 100 further includes outer cylindrical housing 102 arranged on the substrate 101. The outer cylindrical housing may include a sealing cap 106 arranged thereon, which is configured to seal an interior cavity of the outer cylindrical housing 102. The sealing cap 106 may be designed as to seal the outer cylinder, forming a leak tight vessel prior to the assembly being mounted to the aforementioned coldplate or substrate. The outer cylindrical housing 102 and the sealing cap 106 may be formed of any suitable material, including metal and/or plastic.

The outer cylindrical housing 102 may be fixedly attached, and in thermal contact with, the substrate 101 through the use of a plurality of fasteners (not shown). Furthermore, the outer cylindrical housing may include a plurality of gasketed through-holes 105 through which contacts 104 are attached. The contacts 104 may provide electrical communication between an exterior of the inductor assembly and inductor windings within the interior cavity of the outer cylindrical housing 102. The gasketed through-holes 105 may include a through-hole, a sealing gasket, and/or a fastener configured to secure associated contacts 104 within the sealing gaskets. Therefore, the interior cavity of the outer cylindrical housing 102 may be filled with a working fluid with leakage minimized.

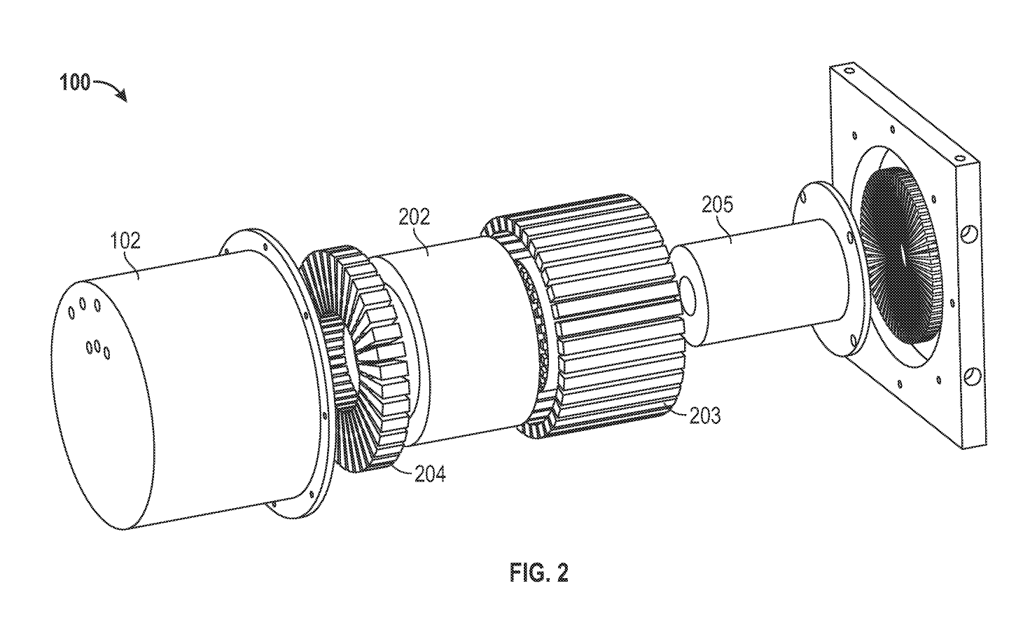

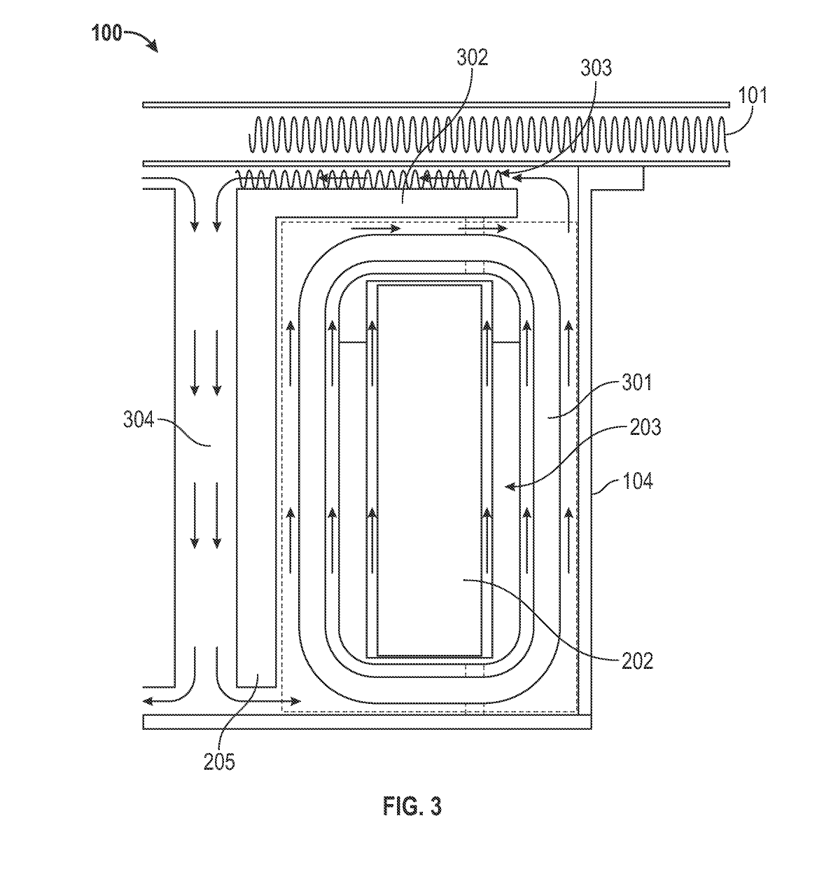

Turning now to FIG. 2, an exploded view of the inductor assembly 100 is provided. The inductor assembly 100 further includes inductor winding bobbin 203 arranged within the outer cylindrical housing 102. The winding bobbin 203 is a plastic or thermoplastic bobbin or any suitable non-conductive structural material configured to secure and support inductor windings 301 (FIG. 3) about an inductor core 202. Therefore, the inductor core 202 is arranged within the winding bobbin 203. The winding bobbin 203 may be of a generally toroidal shape as illustrated, and may include an upper portion 204 configured to further secure and support the inductor windings 301 (FIG. 3). The upper portion 204 may be an integral part of the winding bobbin 203 although illustrated as separate for clarity of discussion. The inductor core 202 may be a ferromagnetic inductive core of a toroid shape and structure.

As further illustrated, the inductor assembly 100 includes an inner cylindrical housing 205 arranged within the winding bobbin 203 and the inductor core 202. The inner cylindrical housing 205 defines an inner cylindrical channel 304 (FIG. 3) configured to allow a working fluid to flow there through.

As described above, inductor assembly 100 includes a plurality of components arranged within a cylindrical housing disposed to further hold a working fluid. Hereinafter, a more detailed description of the interaction of the working fluid and the above-described components is provided with reference to FIGS. 3-7.

FIG. 3 is a cut-away view of a portion of the inductor assembly 100. As shown, the inductor assembly 100 further includes windings 301 wound about the winding bobbin 203. The windings 301 may be conductive windings configured to transmit electricity about and around the inductor core 202. Furthermore, a condensing formation 303 is arranged on the substrate 101 or cover lid. The condensing formation may be a plate fin condenser, a corrugated condenser, a pin fin condenser, a radial fin condenser, or any other suitable condensing formation configured to decrease fluid flow area with respect to length such as a foam. As such, as fluid flows over and through condensing formation 303, the fluid condenses. The property of decreasing flow area with flow length provides several heat transfer benefits in condensation. First, a condensing flow will have a reducing volumetric flow rate which is better matched by the flow area schedule for radially inward flows. This shear flow arrangement keeps velocities high; thinning condensate films and increasing heat transfer coefficients. The higher velocities mitigate back diffusion on non-condensable gases, which could reduce condensation rates. Also the non-condensable gases are swept to the center for easy venting. The shear flow arrangement is inherently more stable because the pressure drops are high than straight flow designs which have significant pressure recovery from velocity.

Turning back to FIG. 3, as described above, the outer cylindrical housing 102 and therefore at least a portion of the inductor assembly 100 may be filled with a working fluid. Thus, the inductor core 202 and windings 301 may be exposed to the working fluid. During operation, heat generated at the core 202 and windings 301 may introduce a thermal gradient which causes the working fluid to flow. With modest heat fluxes, the fluid will flow as a single phase liquid, carrying heat away from components that are dissipating heat. Thus, as flow is introduced between differing temperatures to affect equalization, and overall fluid flow path is created through the inner cylindrical cavity 304, over and through the inductor core 202 and windings 301, and over and through the condensing formation 303. The subsequently condensed working fluid transfers heat to the substrate 101, which may then dissipate the heat to an external environment. At higher heat fluxes, boiling or evaporation will occur on the heat dissipation surfaces with the latent heat of phase change providing the cooling effect. The vapor that is generated, normally in bubbles or slugs is carried by fluid convection and buoyancy to the condenser where the heat of vaporization is removed and the fluid returns to a liquid state. Under some conditions of operation, boiling may occur with the generated bubbles being condensed in a circulating and subcooled liquid. It shall be understood that the term “fluid” herein shall refer to a material that is in a liquid state (single-phase), a vaporized state (e.g., a gas) or any combination thereof.

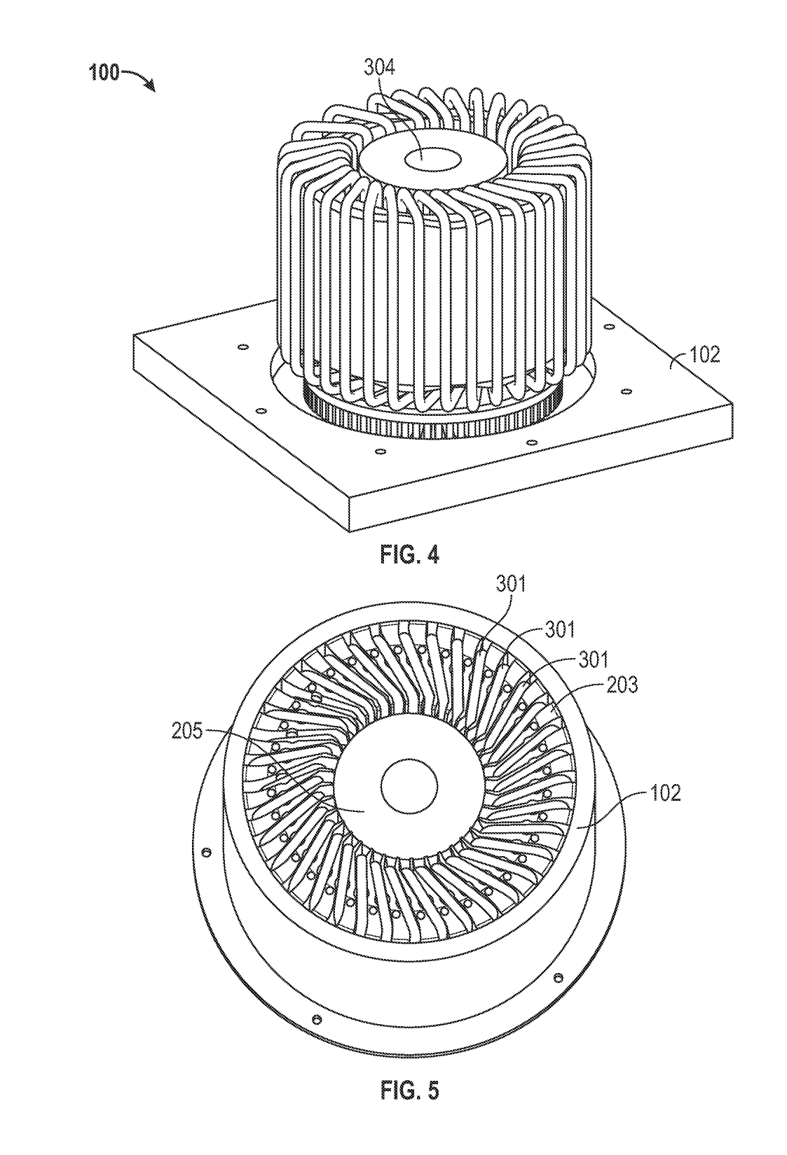

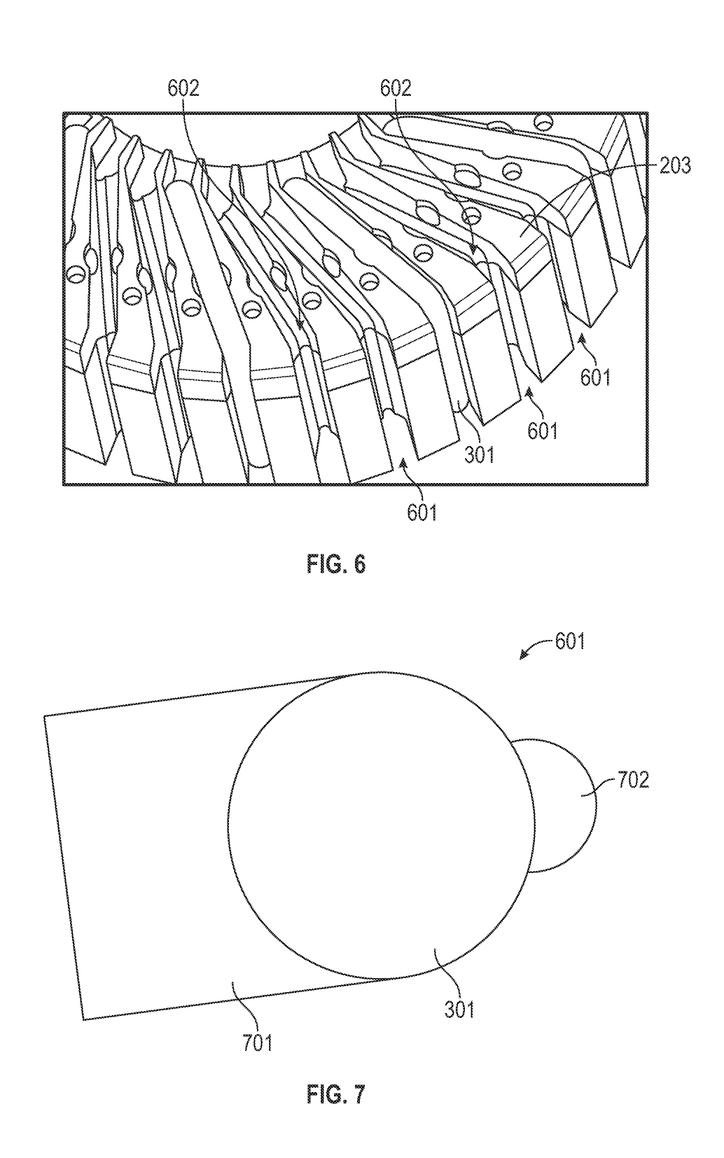

Turning to FIG. 4, an isometric view of a portion of the inductor assembly 100 is illustrated. As shown, sealed working fluid may easily traverse the inner cylindrical cavity 304 and ascend through the windings 301 to be condensed at the condensing formation 303 (FIG. 3). FIGS. 5 and 6 provide detailed top views of the winding bobbin 203. As shown, the windings 301 are secured and supported by winding bobbin 203 such that working fluid flow is not inhibited. For example as shown in FIG. 6, the winding bobbin 203 includes a plurality of axial supportive grooves 601 arranged on an outer diameter and an inner diameter of the winding bobbin 203 and a plurality of radial supporting grooves 602 extending between respective axial grooves.

The axial supportive grooves 601 are configured to support respective windings 301 while also allowing for working fluid penetration about each winding, for example, through inclusion of a cooling channel portion proximate each winding 301. FIG. 7 is a detailed expanded view of a cooling channel portion of the winding bobbin 203. As shown, each axial groove 601 includes a rectangular cross section groove 701 configured to support windings 301 and a semi-circular cooling channel portion 702 proximate the groove 702 and configured to allow working fluid flow therein.

Therefore, as described above, an inductor assembly is provided which is allowing for immersion of an inductor core and winding bobbin within a working fluid. The inductor assembly is configured to route the flow of heated or two-phase working fluid through a condensing formation and transfer heat to a proximate substrate. The cooled working fluid is then transferred through an inner cylindrical cavity back to a distal portion of the inductor core to allow heat transfer to continue through a siphoning effect. The winding bobbin may include a plurality of axial groove configured to support inductor windings while still allowing working fluid flow about each winding, for example, through use of a first rectangular groove portion and a second semicircular groove portion which acts as a cooling channel.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An inductor assembly, comprising:
a substrate;
an outer cylindrical housing arranged on the substrate;
a wound inductor core arranged in the outer cylindrical housing;
a working fluid disposed in the outer cylindrical housing and in contact with the wound inductor core; and
an inner cylindrical housing arranged within the wound inductor core, the inner cylindrical housing defining an inner cylindrical channel configured to transmit working fluid axially through the inductor assembly.

2. (canceled)

3. The inductor assembly of claim 1, further comprising a condensing formation proximate the inner cylindrical housing and the wound inductor core, wherein the condensing formation is configured to condense a portion of circulated working fluid and transmit the condensed portion to the inner cylindrical channel.

4. The inductor assembly of claim 3, wherein the condensing formation is one of: a plate-fin condenser, a pin-fin condenser, a radial fin condenser or a foam condenser.

5. The inductor assembly of claim 1, wherein the wound inductor core comprises:
a winding bobbin;
an inductor core arranged in the winding bobbin; and
a plurality of inductor windings wound about the winding bobbin and the inductor core.

6. The inductor assembly of claim 5, wherein the winding bobbin comprises:
a plurality of axial grooves arranged on an outer surface of the winding bobbin, wherein each axial groove of the plurality of axial grooves is configured to support an inductor winding.

7. The inductor assembly of claim 6, wherein each axial groove of the plurality of axial grooves comprises a first rectangular portion configured to support the inductor winding and a second portion configured to transmit working fluid.

8. The inductor assembly of claim 7, wherein the second portion is a semicircular portion proximate the first rectangular portion.

9. The inductor assembly of claim 1, further comprising a sealing plate arranged on the outer cylindrical housing, the sealing plate configured to seal an interior cavity of the outer cylindrical housing.

10. The inductor assembly of claim 1, wherein the substrate is a cold plate.

11. The inductor assembly of claim 1, wherein the wound inductor core includes a toroid inductor core.

12. The inductor assembly of claim 11, wherein the toroid inductor core is formed of ferromagnetic material.

13. An inductor assembly, comprising:
a substrate;
an outer cylindrical housing arranged on the substrate defining an interior cavity disposed to house a working fluid and a plurality of electrical components;
a wound inductor core arranged in the interior cavity; and
an inner cylindrical housing arranged within the wound inductor core configured to transmit working fluid axially through the inductor assembly.

14. The inductor assembly of claim 13, further comprising a condensing formation proximate the inner cylindrical housing and the wound inductor core, wherein the condensing formation is configured to condense a portion of circulated working fluid and transmit the condensed portion to the inner cylindrical housing.

15. The inductor assembly of claim 14, wherein the condensing formation is a plate-fin condenser.

16. The inductor assembly of claim 13, wherein the wound inductor core comprises:
a winding bobbin;
an inductor core arranged in the winding bobbin; and
a plurality of inductor windings wound about the winding bobbin and the inductor core.

17.-19. (canceled)
